(19) United States
(12) Patent Application Publication
(10) Pub. No.: US 2025/0307144 A1
(43) Pub. Date: Oct. 2, 2025

(54) PREVENTING FRAME LOSS IN A CAMERA SYSTEM

(71) Applicant: MICRON TECHNOLOGY, INC., Boise, ID (US)

(72) Inventors: Qi Dong, Shanghai (CN); Te-Chang Lin, New Taipei City (TW)

(21) Appl. No.: 19/078,567

(22) Filed: Mar. 13, 2025

Related U.S. Application Data
(60) Provisional application No. 63/570,705, filed on Mar. 27, 2024.

(51) Int. Cl. G06F 12/0802; H04N 1/21

(52) U.S. Cl. CPC G06F 12/0802; H04N 1/21; G06F 2212/60

(57) ABSTRACT

A system includes a camera sensor; a first memory component comprising a first memory type; a second memory component comprising a second memory type, wherein the second memory type has a higher access latency than the first memory component; a memory sub-system comprising a third memory component of a third memory type, wherein the third memory component has a higher access latency than the first memory component; and a processing device, operatively coupled with the first memory component, the second memory component, and the memory sub-system, to perform operations including: monitoring a capacity usage status of the first memory component; monitoring a dirty level of the second memory component; determining whether a combination of the capacity usage status and the dirty level satisfies a threshold criterion; and responsive to determining that the combination satisfies the threshold criterion, switching from sending data from the first memory component to the second memory component to sending the data from the first memory component to the memory sub-system, the data comprising frames received from the camera sensor.

### RELATED APPLICATIONS

This application claims the benefit of U.S. Provisional Patent Application No. 63/570,705 filed Mar. 27, 2024, entitled “PREVENTING FRAME LOSS IN A CAMERA SYSTEM”, the contents of which are incorporated by reference in its entirety herein.

### TECHNICAL FIELD

Embodiments of the disclosure relate generally to memory sub-systems, and more specifically, relate to a technique preventing frame loss in a camera system.

### BACKGROUND

A memory sub-system can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing environment that includes a memory sub-system in accordance with some embodiments of the present disclosure.

FIG. 2 is a block diagram illustrating an example camera system preventing frame loss, in accordance with some embodiments of the present disclosure.

FIG. 3 illustrates example threshold criteria that can be used to determine whether a combination of the capacity usage status and the dirty level satisfies, in accordance with some embodiments of the present disclosure.

FIGS. 4 and 5 are flow diagrams of example methods to implement a technique preventing frame loss in a camera system, in accordance with some embodiments of the present disclosure.

FIG. 6 is a block diagram of an example computer system in which embodiments of the present disclosure may operate.

### DETAILED DESCRIPTION

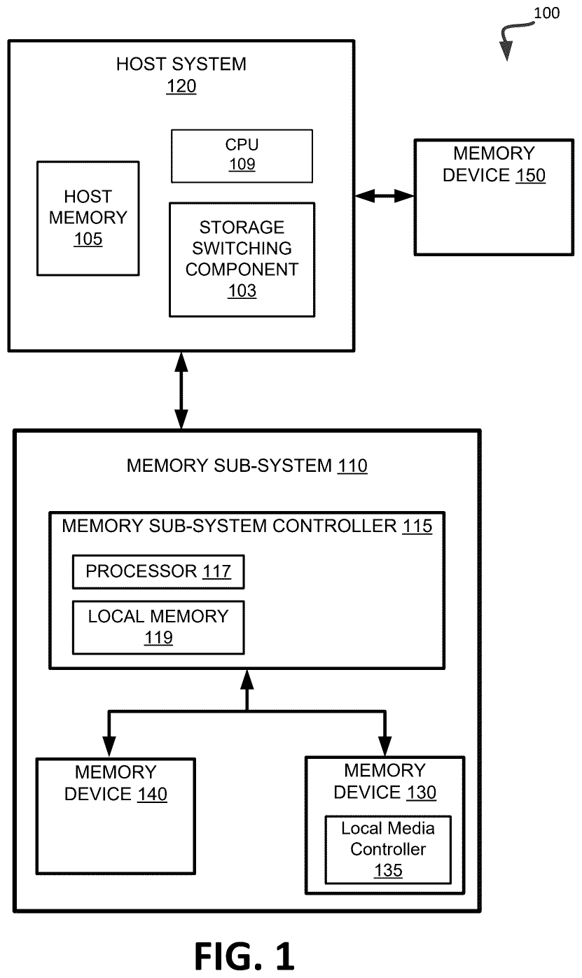

Aspects of the present disclosure are directed to a technique for preventing frame loss in a camera system utilizing a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components such as memory devices that store data. The host system can provide data to be stored at the memory sub-system and can request data to be retrieved from the memory sub-system.

A memory sub-system can include multiple memory devices that can store data from a host system. The memory devices can be non-volatile memory devices, such as negative-and (NAND) memory devices. Other examples of non-volatile memory devices are described below in conjunction with FIG. 1. For some types of non-volatile memory devices (e.g., negative-and (NAND) devices), a non-volatile memory device is a package of one or more die, each die can consist of one or more planes, and each plane consists of a set of physical blocks. Each block consists of a set of pages. Each page consists of a set of memory cells, which store bits of data. The memory sub-system includes a memory sub-system controller that can communicate with the memory devices to perform operations such as reading data, writing data, or erasing data at the memory devices and other such operations. A memory sub-system controller is described in greater detail below in conjunction with FIG. 1.

The host system can send access requests (e.g., write commands, read commands) to the memory sub-system, such as to store data on a memory device at the memory sub-system and to read data from the memory device on the memory sub-system. The data to be read or written, as specified by a host request, is hereinafter referred to as “host data”. A host request can include logical address information (e.g., logical block address (LBA), namespace) for the host data, which is the location the host system associates with the host data. The logical address information (e.g., LBA, namespace) can be part of metadata for the host data. The metadata and host data, together, is hereinafter referred to as “payload.” Metadata, host data, and parity data, which is used for error correction, can collectively form an error correction code (ECC) codeword. Metadata can also include data version (e.g., used to distinguish age of data written), valid bitmap (which LBAs or logical transfer units contain valid data), etc.

An example of a host system is a camera or video system, a recording device of a surveillance system, a recording device used in an automotive industry, or a camera device as a personal consumer product. In a number of memory sub-system applications, such as surveillance video, every video frame captured can be important (e.g., at the original scene of a transportation crash event) and therefore can be stored in a non-volatile memory device. A type of non-volatile memory device, such as micro secure digital (SD) card, is popular because of its removability and cost efficiency. It is important to have a system that can store video frames without losing the video frames captured by a recording device.

In some cases, a camera or video system possesses a limited size of volatile memory used as a cache that is able to properly accept incoming encoded video frame data and writes the data to the non-volatile memory device. Exceeding the cache size will cause video frame data loss. Specifically, the time used for buffering data into the volatile memory (e.g. dynamic random access memory (DRAM)) is less than the time used for writing data to non-volatile memory (e.g., micro SD card), and in some cases, there is no time to release more caches in the volatile memory to accept new data, which can cause video frame data loss.

Aspects of the present disclosure address the above and other deficiencies by providing a camera system that includes a component to monitor the status of volatile memory (e.g., DRAM) and primary non-volatile memory (e.g., micro SD card) and dynamically switch between the primary non-volatile memory (e.g., micro SD card) and the secondary non-volatile memory (e.g., NAND) for storing the host data (e.g., video frame data) based on the monitored status. Specifically, the component of the camera system may monitor a capacity usage status of volatile memory and monitor a capacity usage level (referred to as a dirty level) of the primary non-volatile memory. For example, the component of the camera system may monitor a capacity usage status of volatile memory by reading status data from a register in the volatile memory and determining the capacity usage status according to the status data. For example, the component of the camera system may monitor the dirty level of the primary non-volatile memory by sending a polling command to the primary non-volatile memory and determining the dirty level according to a response received from the primary non-volatile memory.

The component of the camera system may determine whether a combination of the capacity usage status and the dirty level satisfies a threshold criterion, and, responsive to determining that the combination satisfies the threshold criterion, switch from sending data from the volatile memory to the primary non-volatile memory to sending the data from the volatile memory to the secondary non-volatile memory. For example, the component of the camera system may determine that the combination of the capacity usage status of the volatile memory and the dirty level of the primary non-volatile memory satisfies a threshold criterion by determining that the capacity usage status reaches or exceeds a first threshold value and/or the dirty level reaches or exceeds a second threshold value, where each of the first threshold value and the second threshold value are predefined and stored in a data structure. As another example, the component of the camera system may determine that the combination of the capacity usage status of the volatile memory and the dirty level of the primary non-volatile memory satisfies a threshold criterion by determining that the capacity usage status falls in a first threshold range and/or the dirty level falls in a second threshold range, where each of the first threshold range and the second threshold range is predefined and stored in a data structure.

Upon switching to the secondary non-volatile memory, the component of the camera system may provide data (e.g., encoded or not encoded) to be stored at the secondary non-volatile memory and request data to be retrieved from the secondary non-volatile memory. The component of the camera system may send a notification to the primary non-volatile memory, indicating that the primary non-volatile memory can perform a media management operation, such as garbage collection operations, wear leveling operations, etc. to keep the primary non-volatile memory in a good performance state for future usage.

The component of the camera system may keep monitoring the capacity usage status of the volatile memory and the dirty level of the primary non-volatile memory, and determining whether a combination of the capacity usage status of the volatile memory and the dirty level of the primary non-volatile memory satisfies a threshold criterion. Responsive to determining that the combination does not satisfy the threshold criterion, the component of the camera system may switch back from sending the data from volatile memory to secondary non-volatile memory to sending data from volatile memory to primary non-volatile memory. The component of the camera system may send a notification to the secondary non-volatile memory, indicating that the secondary non-volatile memory can perform the media management operation, such as garbage collection operations, wear leveling operations, etc. to keep the secondary non-volatile memory in a good performance state for future usage.

Advantages of the present disclosure include preventing loss of frame, which may prevent degradation of video quality or loss of important video information. Aspects of the present disclosure ensure integrity of recording data and enhance customer experience in effectively avoiding the occurrence of frame loss. Aspects of the present disclosure also reduce the memory design complexity in camera system, lower the requirement of performance optimization of non-volatile memory, such as firmware algorithm, performance tuning, etc. Aspects of the present disclosure further reduce the cost by leveraging the boot storage device or other on-board non-volatile memory device and avoid the need of fast-tuned managed NAND chips with higher cost.

FIG. 1 illustrates an example computing environment 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory. A 3D cross-point memory device is a cross-point array of non-volatile memory cells that can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased.

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. Some types of memory, such as 3D cross-point, can group pages across dice and channels to form management units.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processors.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The host system 120 can be coupled to a memory device 150 via a physical host interface. In some implementations, the memory device 150 may be secure digital (SD) card, a mini SD card, or a micro SD card, that can be used in a portable computing device, such as the host system 120. The host system 120 may include a host memory 105 (e.g., DRAM) or other main memories. In some implementations, the host system 120 includes a central processing unit (CPU) 109 connected to the host memory 105. CPU 109 can be a processor or system-on-a-chip (SOC) comprising an arithmetic logic unit, a management unit, etc. to execute instructions associated with applications executed by the host system 120. The host memory 105 may include one or more levels of cache memory for quick data access to highly accessed, or recently accessed data. In some embodiments, the host memory 105 or the CPU 109 can include a cache controller to determine which data to cache at the different levels of cache memory.

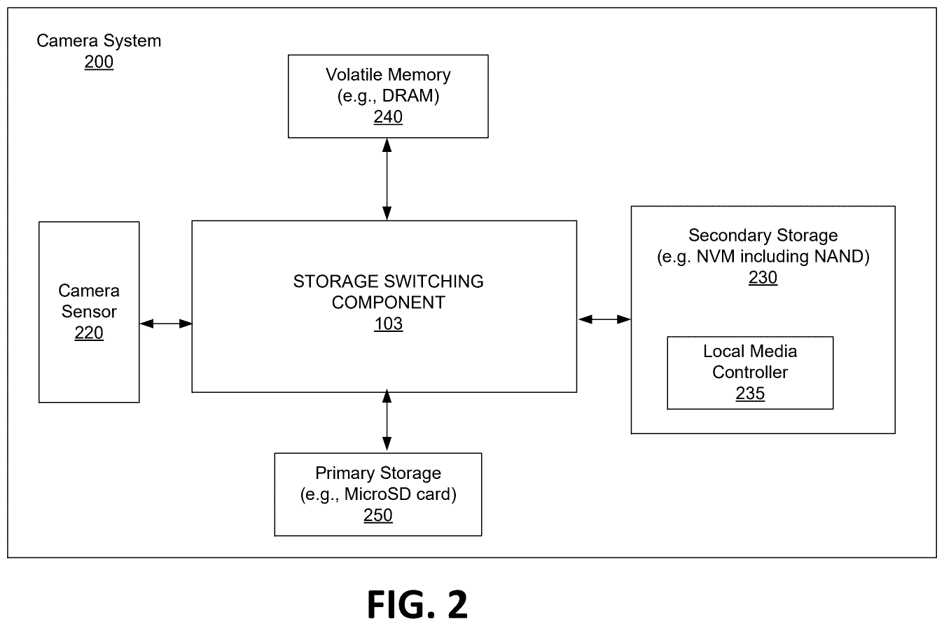

The host system 120 may include a storage switching component 103 that can perform storage switching between the memory device 150 and the memory sub-system 110 to prevent frame loss. In some embodiments, the storage switching component 103 is part of the CPU 109, an application, or an operating system. In some embodiments, the memory sub-system controller 115 includes at least a portion of the storage switching component 103. For example, the memory sub-system controller 115 can include a processor 117 (processing device) configured to execute instructions stored in local memory 119 for performing the operations described herein. Further details with regards to the operations of the storage switching component 103 are described below with respect to FIGS. 2-6.

FIG. 2 is a block diagram illustrating a camera system 200 including a storage switching component 103. The camera system 200 may include a camera sensor 220, a volatile memory 240, the storage switching component 103, a primary storage device 250, and a secondary storage device 230. In some implementations, the volatile memory 240 may be the host memory 105 included in the host system 120, and the storage switching component 103 may perform the functionality of the CPU 109 included in the host system 120. In some implementations, the primary storage device 250 may be the memory device 150. In some implementations, the secondary storage device 230 may be the memory device 130 included in the memory sub-system 110. In some implementations, the storage switching component 103 may be a system-on-a-chip (SOC).

The camera sensor 220 may provide data, such as video frame data, to the storage switching component 103. The storage switching component 103 may include software or hardware that encodes (e.g., compresses) and decodes (e.g., decompresses) the data. The storage switching component 103 may utilize the volatile memory 240 (e.g., DRAM) as a data cache to provide lower latency access to data. Lower latency access can mean faster access speeds while higher latency access can mean slower access speeds. The storage switching component 103 may provide data (e.g., encoded or not encoded) to be stored at the primary storage device 250 (e.g., micro SD card) and can request data to be retrieved from the primary storage device 250.

The storage switching component 103 can include different interfaces to communicate with volatile memory 240 (e.g., DRAM), primary storage device 250 (e.g., micro SD card), and secondary storage device 230 (e.g., non-volatile memory such as NAND). The storage switching component 103 can provide a first interface to volatile memory 240 (e.g., DRAM), a second interface to primary storage device 250 (e.g., micro SD card), and a third interface to secondary storage device 230 (e.g., non-volatile memory such as NAND). The primary storage device 250 (e.g., micro SD card) has a higher access latency than the volatile memory 240 (e.g., DRAM). The secondary storage device 230 (e.g., non-volatile memory such as NAND) may have a higher access latency than the volatile memory 240 (e.g., DRAM). In some implementations, the primary storage device 250 (e.g., micro SD card) may have a higher access latency than the secondary storage device 230 (e.g., non-volatile memory such as NAND, Embedded MultiMedia Card (eMMC)).

As data that is read or written at the primary storage device 250 can be cached at the volatile memory 240, the storage switching component 103 may include one or more components to monitor the capacity usage status of the volatile memory 240 and the dirty level of the primary storage device 250.

In some implementations, the storage switching component 103 may monitor the capacity usage status of the volatile memory 240 by reading status data from a register in the volatile memory 240 and determining the capacity usage status according to the status data. For example, the storage switching component 103 may send a command to read configuration and status data from mode registers associated with the volatile memory 240, and the volatile memory 240 may send a response including the status data as a result. The storage switching component 103 may use the status data directly to represent the capacity usage status of the volatile memory 240. The storage switching component 103 may perform some computations on the status data to derive the capacity usage status of the volatile memory 240.

In some implementations, the storage switching component 103 may monitor the dirty level of the primary storage device 250 by sending a polling command to the primary storage device 250 and receiving a response from the primary storage device 250, where the response includes status of the primary storage device 250. The dirty level may refer to a capacity usage level of the primary storage device 250. For example, the storage switching component 103 may send a polling command (e.g., CMD56) and receive a response, of the polling command, that includes several bits (e.g., bit [39:8]) representing the status of the primary storage device 250. The storage switching component 103 may use the status bits directly to represent the dirty level of the primary storage device 250. For example, the bits included in the response may be 3 bits representing 8 dirty level, i.e., 8 levels of capacity usage of the primary storage device 250, where the first level represents a lowest capacity usage level (e.g., measured by a percentage, such as 1%), . . . , and the eighth level represents a highest capacity usage level (e.g., measured by a percentage, such as 100%). The storage switching component 103 may perform some computations on the status bits to derive the dirty level of the primary storage device 250.

The storage switching component 103 may determine whether a combination of the capacity usage status of the volatile memory 240 and the dirty level of the primary storage device 250 satisfies a threshold criterion. In some implementations, the storage switching component 103 may determine whether the capacity usage status of the volatile memory 240 and the dirty level of the primary storage device 250 each reach or exceed respective threshold values. For example, the storage switching component 103 may determine that a combination of the capacity usage status of the volatile memory 240 and the dirty level of the primary storage device 250 satisfies a threshold criterion, responsive to determining that the capacity usage status of the volatile memory 240 reaches or exceeds a first threshold value and the dirty level of the primary storage device 250 reaches or exceeds a second threshold value. In some implementations, each of the first threshold value and the second threshold value is predefined and stored in a data structure.

In some implementations, the storage switching component 103 may determine whether each of the capacity usage status of the volatile memory 240 and the dirty level of the primary storage device 250 falls in a respective threshold range. For example, the storage switching component 103 may determine that a combination of the capacity usage status of the volatile memory 240 and the dirty level of the primary storage device 250 satisfies a threshold criterion, responsive to determining that the capacity usage status of the volatile memory 240 falls in a first threshold range and/or the dirty level of the primary storage device 250 falls in a second threshold range. In some implementations, each of the first threshold range and the second threshold range is predefined and stored in a data structure.

Responsive to the combination of the capacity usage status of the volatile memory 240 and the dirty level of the primary storage device 250 satisfies a threshold criterion, the storage switching component 103 may switch from sending data from volatile memory 240 to primary storage device 250 to sending the data from volatile memory 240 to secondary storage device 230.

Responsive to the combination of the capacity usage status of the volatile memory 240 and the dirty level of the primary storage device 250 does not satisfy a threshold criterion, the storage switching component 103 may keep using the primary storage device 250 as the storage, without switching from sending data from volatile memory 240 to primary storage device 250 to sending the data from volatile memory 240 to secondary storage device 230.

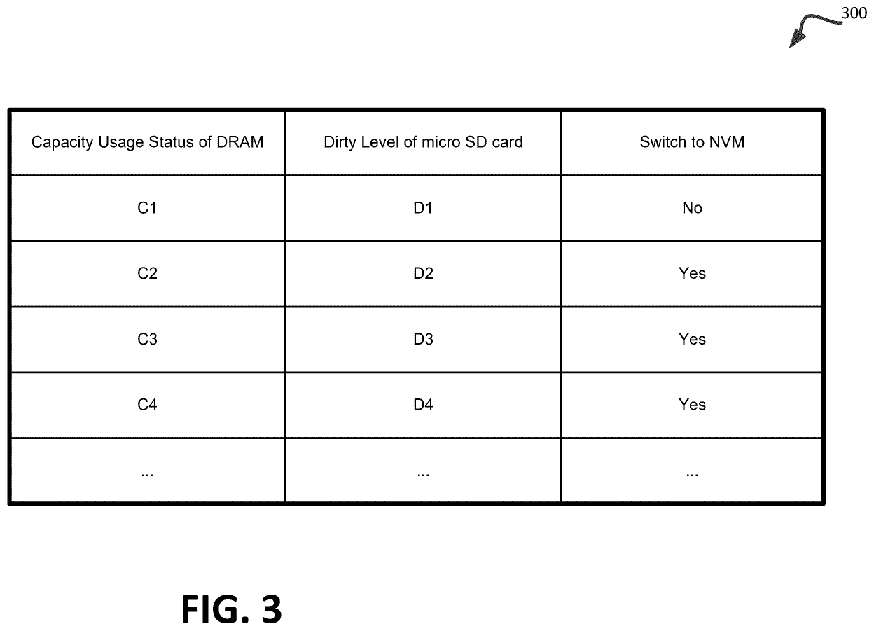

FIG. 3 illustrates example threshold criteria that can be used to determine whether a combination of the capacity usage status and the dirty level satisfies a threshold criterion. Using as an illustrative example that the first memory type corresponds to dynamic random access memory (DRAM), wherein the second memory type corresponds to a micro secure digital (SD) card, and wherein the third memory type corresponds to a non-volatile memory (NVM), the data structure 300 may store the threshold values (or ranges) used in the threshold criterion. The data structure 300 may include a field indicating the capacity usage status of DRAM, a field indicating the dirty level of micro SD card, and a field indicating whether to switch from micro SD card to NVM for storage of the data. Each of the field indicating the capacity usage status of DRAM and the field indicating the dirty level of micro SD card may have a value or a range of values.

For example, C1 may be 40%, D1 may be 4, and the switch indicates no, that is, when capacity usage status of DRAM is 40% and dirty level of the micro SD card is 4, the processing device determines that the threshold criterion is not satisfied to switch from sending data from DRAM to micro SD card to sending data from DRAM to NVM. As another example, C2 may be 40%, D2 may be 6, and the switch indicates yes, that is, when capacity usage status of DRAM is 40% and dirty level of the micro SD card is 6, the processing device determines that the threshold criterion is satisfied to switch from sending data from DRAM to micro SD card to sending data from DRAM to NVM. As yet another example, C3 may be 75%, D3 may be 4, and the switch indicates yes, that is, when capacity usage status of DRAM is 75% and dirty level of micro SD card is 4, the processing device determines that the threshold criterion is satisfied to switch from sending data from DRAM to micro SD card to sending data from DRAM to NVM. As yet another example, C4 may be 75%, D4 may be 6, and the switch indicates yes, that is, when capacity usage status of DRAM is 75% and dirty level of micro SD card is 6, the processing device determines that the threshold criterion is satisfied to switch from sending data from DRAM to micro SD card to sending data from DRAM to NVM.

In some implementations, C1 may be a range from 0% to 75% excluding 75% (i.e., 0%≤C1<75%), D1 may be a range from 0 to 6 excluding 6 (i.e., 0≤D1<6), and the switch indicates no, that is, when capacity usage status of DRAM is less than 75% and dirty level of micro SD card is less than 6, the processing device determines that the threshold criterion is not satisfied to switch from sending data from DRAM to micro SD card to sending data from DRAM to NVM. In some implementations, C2 may be a range from 0% to 75% excluding 75% (i.e., 0%≤C2<75%), D2 may be a range reaching or exceeding 6 (i.e., D2≥6), and the switch indicates yes, that is, when capacity usage status of DRAM is less than 75% and dirty level of micro SD card is equal to or more than 6, the processing device determines that the threshold criterion is satisfied to switch from sending data from DRAM to micro SD card to sending data from DRAM to NVM. In some implementations, C3 may be a range reaching or exceeding 75% (i.e., C3≥75%), D3 may be a range from 0 to 6 excluding 6 (i.e., 0≤D3<6), and the switch indicates yes, that is, when capacity usage status of DRAM is equal to or more than 75% and dirty level of micro SD card is less than 6, the processing device determines that the threshold criterion is satisfied to switch from sending data from DRAM to micro SD card to sending data from DRAM to NVM. In some implementations, C4 may be a range reaching or exceeding 75% (i.e., C4≥75%), D4 may be a range reaching or exceeding 6 (i.e., D4≥6), and the switch indicates yes, that is, when capacity usage status of DRAM is equal to or more than 75% and dirty level of micro SD card is equal to or more than 6, the processing device determines that the threshold criterion is satisfied to switch from sending data from DRAM to micro SD card to sending data from DRAM to NVM.

Referring back to FIG. 2, when the primary storage device 250 is used as storage (e.g., not switched), the storage switching component 103 can provide data (e.g., encoded or not encoded) to be stored at the primary storage device 250 and can request data to be retrieved from the primary storage device 250. The storage switching component 103 may send a notification to the secondary storage device 230 to indicate that the secondary storage device 230 is not currently receiving data for storage, and in response to the notification, the secondary storage device 230 (e.g., through the local media controller) can perform a media management operation, such as garbage collection operations, wear leveling operations, etc. to keep the secondary storage device 230 in a good performance state for future usage.

When the secondary storage device 230 is used as storage (e.g., switched), the storage switching component 103 can provide data (e.g., encoded or not encoded) to be stored at the secondary storage device 230 and can request data to be retrieved from the secondary storage device 230. The storage switching component 103 may send a notification (e.g., regarding the switching) to the primary storage device 250 to indicate that the primary storage device 250 is not currently receiving data for storage, and in response to the notification, the primary storage device 250 can perform a media management operation, such as garbage collection operations, wear leveling operations, etc. to keep the primary storage device 250 in a good performance state for future usage.

The storage switching component 103 may keep monitoring the capacity usage status of the volatile memory 240 and the dirty level of the primary storage device 250, and determining whether a combination of the capacity usage status of the volatile memory 240 and the dirty level of the primary storage device 250 satisfies a threshold criterion. Responsive to determining that the combination does not satisfy the threshold criterion any longer, the storage switching component 103 may switch back from sending the data from volatile memory 240 to secondary storage device 230 to sending data from volatile memory 240 to primary storage device 250. The storage switching component 103 may send a notification to the secondary storage device 230, indicating that the secondary storage device 230 is not currently receiving data for storage, so that the secondary storage device 230 can perform the media management operation.

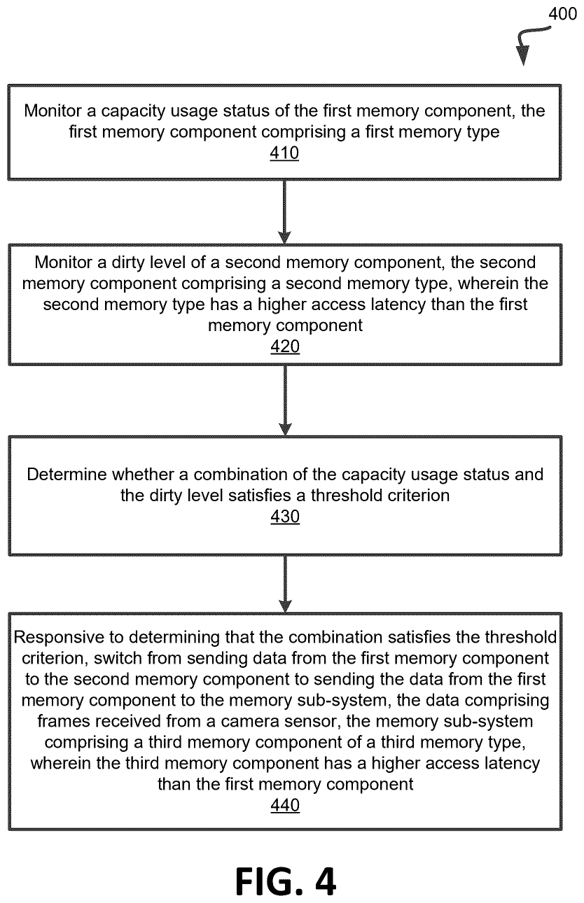

FIG. 4 is a flow diagram of an example method 400 to implement storage switching to prevent frame loss, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the storage switching component 103 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing device monitors a capacity usage status of the first memory component (e.g., volatile memory 240) comprising a first memory type. In some implementations, the first memory component comprising a first memory type may be a non-volatile memory used as a cache memory. The first memory component may be a low latency, low capacity type of memory, such as DRAM, which may have a large enough capacity to perform as a cache for the larger capacity non-volatile memory. In some implementations, the first memory type corresponds to dynamic random access memory (DRAM). In some implementations, the processing device reads status data from a register in the first memory component and determines the capacity usage status according to the status data.

At operation 420, the processing device monitors a dirty level of the second memory component (e.g., primary storage 250) comprising a second memory type, wherein the second memory type has a higher access latency than the first memory component. In some implementations, the second memory type corresponds to a secure digital (SD) card. In some implementations, the processing device sends, to the second memory component, a polling command, receives, from the second memory component, a response to the polling command, and determines the dirty level according to the response.

At operation 430, the processing device determines whether a combination of the capacity usage status and the dirty level satisfies a threshold criterion. In some implementations, the processing device determines whether the capacity usage status reaches or exceeds a first threshold value and determines whether the dirty level reaches or exceeds a second threshold value. In some implementations, each of the first threshold value and the second threshold value is predefined and stored in a data structure.

At operation 440, responsive to determining that the combination satisfies the threshold criterion, the processing device switches from sending data from the first memory component (e.g., volatile memory 240) to the second memory component (e.g., primary storage 250) to sending the data from the first memory component (e.g., volatile memory 240) to the memory sub-system (e.g., secondary storage 230), the data comprising frames received from the camera sensor. In some implementations, the memory sub-system comprises the third memory component comprising the third memory type that corresponds to a non-volatile memory (NVM). In some implementations, the second memory component has a higher access latency than the third memory component. In some implementations, the processing device sends a notification of the switching to the second memory component, wherein the second memory component performs a media management operation in response to the notifying.

In some implementations, after switching, responsive to determining that the combination does not satisfy the threshold criterion, the processing device switches back from sending data from the first memory component to the memory sub-system to sending the data from the first memory component to the second memory component. In some implementations, the processing device sends a notification of the switching back to the memory sub-system, wherein the memory sub-system performs a media management operation on the third memory component in response to the notifying.

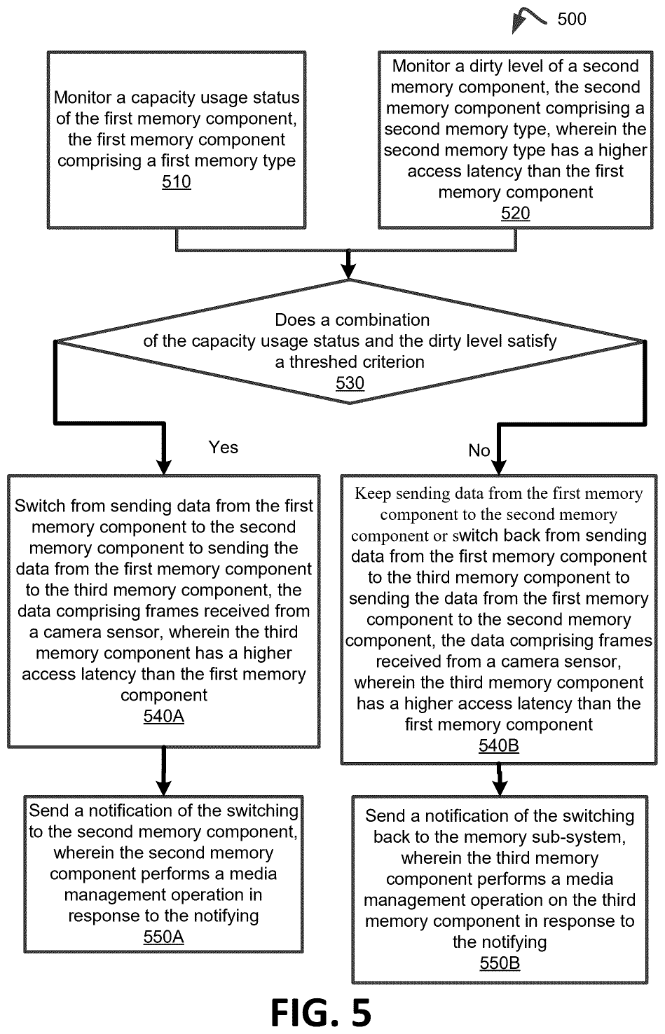

FIG. 5 is a flow diagram of an example method 500 to implement storage switching to prevent frame loss, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the caching component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing device monitors a capacity usage status of the first memory component comprising a first memory type, which can be similar to or same as the operation 410.

At operation 520, the processing device monitors a dirty level of the second memory component comprising a second memory type, wherein the second memory type has a higher access latency than the first memory component, which can be similar to or same as the operation 420.

At operation 530, the processing device determines whether a combination of the capacity usage status and the dirty level satisfies a threshold criterion, which can be similar to or same as the operation 430.

At operation 540A, responsive to determining that the combination satisfies the threshold criterion, the processing device switches from sending data from the first memory component (e.g., volatile memory 240) to the second memory component (e.g., primary storage 250) to sending the data from the first memory component (e.g., volatile memory 240) to the third memory component (e.g., secondary storage 230), the data comprising frames received from a camera sensor, wherein the third memory component has a higher access latency than the first memory component, which can be similar to or same as the operation 440.

At operation 540B, responsive to determining that the combination does not satisfy the threshold criterion, the processing device keeps sending data from the first memory component (e.g., volatile memory 240) to the second memory component (e.g., primary storage 250) or switches back from sending the data from the first memory component (e.g., volatile memory 240) to third memory component (e.g., secondary storage 230) to sending data from the first memory component (e.g., volatile memory 240) to the second memory component (e.g., primary storage 250), for example, after operation 540A, the data comprising frames received from the camera sensor, wherein the third memory component has a higher access latency than the first memory component.

At operation 550A, the processing device sends a notification of the switching to the second memory component (e.g., primary storage 250), wherein the second memory component performs a media management operation in response to the notifying.

At operation 550B, the processing device sends a notification of the keeping or the switching back to the third memory component (e.g., secondary storage 230), wherein the third memory component performs a media management operation on the third memory component in response to the notifying.

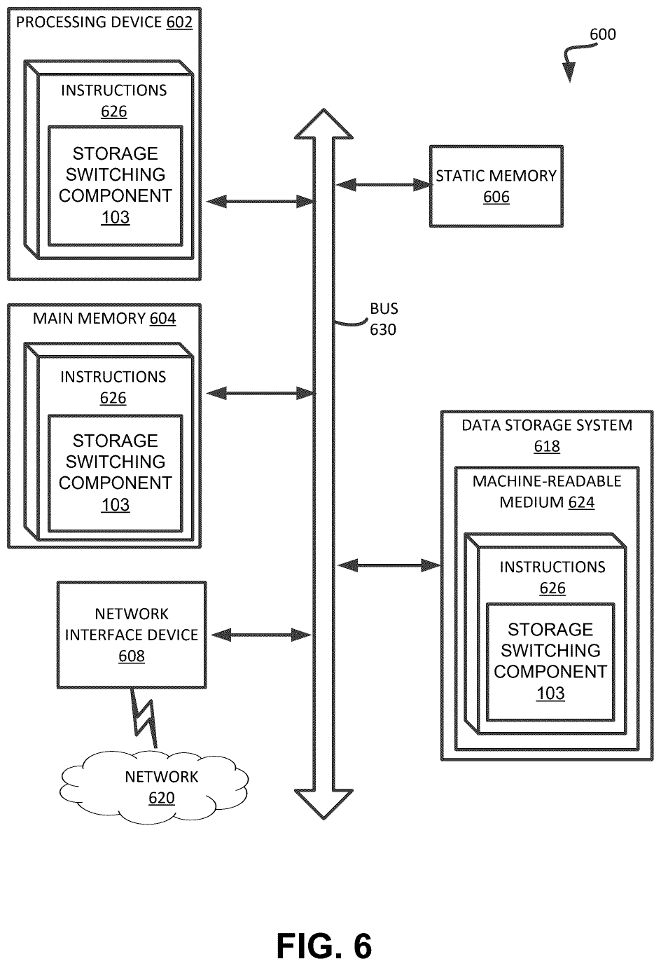

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the storage switching component 103 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a caching component (e.g., the storage switching component 103 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a camera sensor;
a first memory component comprising a first memory type;
a second memory component comprising a second memory type, wherein the second memory type has a higher access latency than the first memory component;
a memory sub-system comprising a third memory component of a third memory type, wherein the third memory component has a higher access latency than the first memory component; and
a processing device, operatively coupled with the first memory component, the second memory component, and the memory sub-system, to perform operations comprising:
monitoring a capacity usage status of the first memory component;
monitoring a dirty level of the second memory component;
determining whether a combination of the capacity usage status and the dirty level satisfies a threshold criterion; and
responsive to determining that the combination satisfies the threshold criterion, switching from sending data from the first memory component to the second memory component to sending the data from the first memory component to the memory sub-system, the data comprising frames received from the camera sensor.

2. The system of claim 1, wherein the first memory type corresponds to dynamic random access memory (DRAM), wherein the second memory type corresponds to a secure digital (SD) card, and wherein the third memory type corresponds to a non-volatile memory (NVM).

3. The system of claim 1, wherein the operations further comprise:
sending a notification of the switching to the second memory component, wherein the second memory component performs a media management operation in response to the notifying.

4. The system of claim 1, wherein the operations further comprise:
after switching, responsive to determining that the combination does not satisfy the threshold criterion, switching back from sending data from the first memory component to the memory sub-system to sending the data from the first memory component to the second memory component.

5. The system of claim 4, wherein the operations further comprise:
sending a notification of the switching back to the memory sub-system, wherein the memory sub-system performs a media management operation on the third memory component in response to the notifying.

6. The system of claim 1, wherein monitoring the capacity usage status of the first memory component further comprises:
reading status data from a register in the first memory component; and
determining the capacity usage status according to the status data.

7. The system of claim 1, wherein monitoring the dirty level of the second memory component further comprises:
sending, to the second memory component, a polling command;
receiving, from the second memory component, a response to the polling command;
determining the dirty level according to the response. and

8. The system of claim 1, wherein determining whether the combination of the capacity usage status and the dirty level satisfies the threshold criterion further comprises at least one of:
determining whether the capacity usage status reaches or exceeds a first threshold value; or
determining whether the dirty level reaches or exceeds a second threshold value.

9. The system of claim 8, wherein each of the first threshold value and the second threshold value is predefined and stored in a data structure.

10. The system of claim 1, wherein the second memory component has a higher access latency than the third memory component.

11. A method comprising:
monitoring, by a processing device operatively coupled with a first memory component, a second memory component, and a memory sub-system, a capacity usage status of the first memory component, the first memory component comprising a first memory type;
monitoring a dirty level of the second memory component, the second memory component comprising a second memory type, wherein the second memory type has a higher access latency than the first memory component;
determining whether a combination of the capacity usage status and the dirty level satisfies a threshold criterion; and
responsive to determining that the combination satisfies the threshold criterion, switching from sending data from the first memory component to the second memory component to sending the data from the first memory component to the memory sub-system, the memory sub-system comprising a third memory component of a third memory type, wherein the third memory component has a higher access latency than the first memory component.

12. The method of claim 11, wherein the first memory type corresponds to dynamic random access memory (DRAM), wherein the second memory type corresponds to a secure digital (SD) card, and wherein the third memory type corresponds to a non-volatile memory (NVM).

13. The method of claim 11, wherein the operations further comprise:
sending a notification of the switching to the second memory component, wherein the second memory component performs a media management operation in response to the notifying.

14. The method of claim 11, wherein the operations further comprise:
after switching, responsive to determining that the combination does not satisfy the threshold criterion, switching back from sending data from the first memory component to the memory sub-system to sending the data from the first memory component to the second memory component.

15. The method of claim 14, wherein the operations further comprise:
sending a notification of the switching back to the memory sub-system, wherein the memory sub-system performs a media management operation on the third memory component in response to the notifying.

16. A non-transitory computer-readable storage medium comprising instructions that, when executed by a processing device operatively coupled with a first memory component, a second memory component, and a memory sub-system, cause the processing device to perform operations comprising:
monitoring a capacity usage status of the first memory component, the first memory component comprising a first memory type;
monitoring a dirty level of a second memory component, the second memory component comprising a second memory type, wherein the second memory type has a higher access latency than the first memory component;
determining whether a combination of the capacity usage status and the dirty level satisfies a threshold criterion; and
responsive to determining that the combination satisfies the threshold criterion, switching from sending data from the first memory component to the second memory component to sending the data from the first memory component to the memory sub-system, the data comprising frames received from a camera sensor, the memory sub-system comprising a third memory component of a third memory type, wherein the third memory component has a higher access latency than the first memory component.

17. The non-transitory computer-readable storage medium of claim 16, wherein the first memory type corresponds to dynamic random access memory (DRAM), wherein the second memory type corresponds to a secure digital (SD) card, and wherein the third memory type corresponds to a non-volatile memory (NVM).

18. The non-transitory computer-readable storage medium of claim 16, wherein the operations further comprise:
sending a notification of the switching to the second memory component, wherein the second memory component performs a media management operation in response to the notifying.

19. The non-transitory computer-readable storage medium of claim 16, wherein determining whether the combination of the capacity usage status and the dirty level satisfies the threshold criterion further comprises at least one of:
determining whether the capacity usage status reaches or exceeds a first threshold value; or
determining whether the dirty level reaches or exceeds a second threshold value.

20. The non-transitory computer-readable storage medium of claim 16, wherein the second memory component has a higher access latency than the third memory component.
